(19) United States
(12) Patent Application Publication
(10) Pub. No.: US 2017/0081737 A1
(43) Pub. Date: Mar. 23, 2017

(54) COOLING APPARATUS AND MULTI-CHAMBER HEAT TREATMENT APPARATUS

(71) Applicants: IHI Corporation, Tokyo (JP); IHI Machinery and Furnace Co., Ltd., Tokyo (JP)

(72) Inventors: Kazuhiko KATSUMATA, Inuyama-shi (JP); Kaoru ISOMOTO, Tokyo (JP); Takahiro NAGATA, Kamo-gun (JP); Akira NAKAYAMA, Hikari-shi (JP); Yuusuke SHIMIZU, Gifu-shi (JP); Gen NISHITANI, Kakamigahara-shi (JP)

(73) Assignees: IHI Corporation, Tokyo (JP); IHI Machinery and Furnace Co., Ltd., Tokyo (JP)

(21) Appl. No.: 15/289,804

(22) Filed: Oct. 10, 2016

Related U.S. Application Data
(63) Continuation of application No. PCT/JP2015/064928, filed on May 25, 2015.

(30) Foreign Application Priority Data
May 29, 2014 (JP) 2014-111545

(51) Int. Cl. C21D 9/00; C21D 1/56; F27D 9/00; C21D 1/667

(52) U.S. Cl. CPC C21D 9/0062; C21D 1/667; C21D 1/56; F27D 9/00; F27D 2009/0089; F27D 2009/0081

(57) ABSTRACT

A cooling apparatus includes: cooling nozzles which are disposed around an object to be treated accommodated inside a cooling room and spray a cooling medium onto the object to be treated; a header pipe communicating with the cooling nozzles; and a cooling pump which supplies the cooling medium to the header pipe. The cooling nozzles are divided into groups. The header pipe is provided in each of the groups of the cooling nozzles.

This application is a Continuation Application based on International Application No. PCT/JP2015/064928, filed May 25, 2015, which claims priority on Japanese Patent Application No. 2014-111545, filed May 29, 2014, the contents of which are incorporated herein by reference.

### TECHNICAL FIELD

The present disclosure relates to a cooling apparatus and a multi-chamber heat treatment apparatus.

### BACKGROUND

Patent Document 1 listed below discloses a multi-chamber heat treatment apparatus in which a cooling room and three heating rooms are connected through an intermediate transfer room. The multi-chamber heat treatment apparatus is configured so that the three heating rooms are provided above the intermediate transfer room and the cooling room is provided below the intermediate transfer room. An object to be treated positioned in the intermediate transfer room is loaded by a lifter into the cooling room from the upper side of the cooling room, and the object is unloaded thereby from the cooling room. The multi-chamber heat treatment apparatus performs cooling (mist-cooling) using mist of a cooling medium against the object to be treated loaded into the center of the cooling room by spraying (misting) the cooling medium thereonto from nozzles provided in positions in a side area of the object to be treated. Each of the nozzles is supplied with the cooling medium from a cooling medium pump through a header pipe.

Patent Document 2 listed below discloses a quenching apparatus including nozzles capable of spraying a cooling medium. Patent Document 3 listed below discloses a heat treatment furnace including a spray device for a cooling medium.

Patent Document 4 listed below discloses a water header pipe of an air-water cooling apparatus.

### DOCUMENT OF RELATED ART

### Patent Document

[Patent Document 1] Japanese Unexamined Patent Application, First Publication No. 2014-051695

[Patent Document 2] Japanese Unexamined Patent Application, First Publication No. S58-141323

[Patent Document 3] Japanese Unexamined Patent Application, First Publication No. H7-90356

[Patent Document 4] Japanese Unexamined Patent Application, First Publication No. 2004-315920

### SUMMARY

### Technical Problem

In the multi-chamber heat treatment apparatus of Patent Document 1, it may be difficult to spray a cooling medium from nozzles onto an object to be treated so that its quantity is uniform, and thereby to uniformly cool various parts of the object to be treated. In a heat treatment apparatus that performs an intended heat treatment on an object to be treated by heating the object to be treated in a heating room and by cooling the object to be treated in a cooling room, non-uniformity in cooling of the object to be treated is a non-negligible and very important technical issue.

The present disclosure has been made in view of the above circumstances, and an object thereof is to provide a cooling apparatus and a multi-chamber heat treatment apparatus that can perform more uniform mist-cooling than that in the related art.

### Solution to Problem

In order to reach the above object, a first aspect of the present disclosure is a cooling apparatus including: cooling nozzles which are disposed around an object to be treated accommodated inside a cooling room and spray a cooling medium onto the object to be treated; a header pipe communicating with the cooling nozzles; and a cooling pump which supplies the cooling medium to the header pipe. The cooling nozzles are divided into groups. In addition, the header pipe is provided in each of the groups of the cooling nozzles.

A second aspect of the present disclosure is that in the cooling apparatus of the first aspect, the cooling nozzles are divided into two or more groups in a lateral direction of the object to be treated.

A third aspect of the present disclosure is that in the cooling apparatus of the first or second aspect, the cooling nozzles are provided in multilevel in an up-and-down direction in a side area of the object to be treated.

A fourth aspect of the present disclosure is that in the cooling apparatus of the third aspect, a cooling nozzle of the uppermost level of the cooling nozzles is disposed in a higher position than the upper end of the object to be treated, and is disposed in an inner area of a cooling nozzle of another level of the cooling nozzles inside the cooling room.

A fifth aspect of the present disclosure is that in the cooling apparatus of any one of the first to fourth aspects, the header pipe is provided around the object to be treated, and is formed so that the distances between the header pipe and the cooling nozzles are equal to each other.

A sixth aspect of the present disclosure is a multi-chamber heat treatment apparatus including: a heating apparatus that heats an object to be treated; and the cooling apparatus of any one of the first to fifth aspects.

### Effects

According to the present disclosure, since the header pipe is provided in each of the groups of the cooling nozzles, it is possible to limit variation in the spray quantity of the cooling medium from the cooling nozzles due to a pressure loss of the header pipe compared to a case where a cooling medium is supplied to cooling nozzles through a single header pipe. Therefore, according to the present disclosure, it is possible to more uniformly spray a cooling medium onto an object to be treated than the related art, and thus to perform more uniform mist-cooling than that in the related art.

### BRIEF DESCRIPTION OF DRAWINGS

FIG. 1 is a first vertical cross-sectional view showing an overall configuration of a cooling apparatus and a multi-chamber heat treatment apparatus of an embodiment of the present disclosure.

FIG. 2 is a second vertical cross-sectional view showing the overall configuration of the cooling apparatus and the multi-chamber heat treatment apparatus of the embodiment of the present disclosure.

FIG. 3 is a vertical cross-sectional view showing an overall configuration of the cooling apparatus of the embodiment of the present disclosure.

FIG. 4 is a cross-sectional view taken along IV-IV line in FIG. 2.

FIG. 5 is a cross-sectional view taken along V-V line in FIG. 2.

FIG. 6 is a cross-sectional view taken along VI-VI line in FIG. 2.

### DESCRIPTION OF EMBODIMENTS

Hereinafter, an embodiment of the present disclosure is described with reference to the drawings.

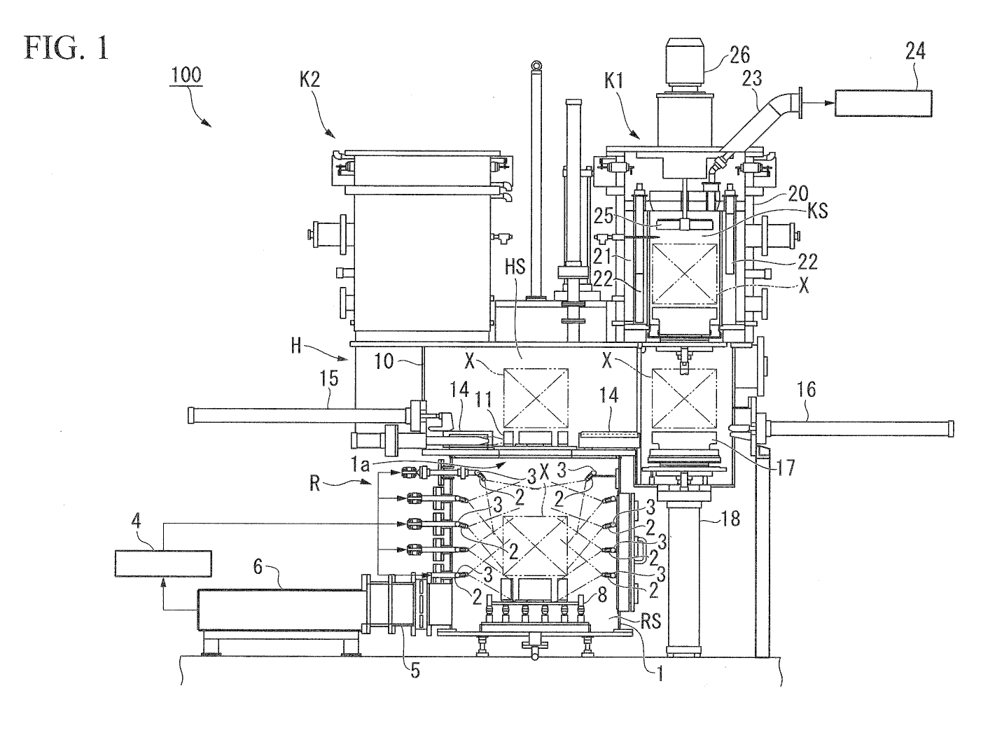

As shown in FIG. 1, a multi-chamber heat treatment apparatus 100 of this embodiment is an apparatus in which a cooling apparatus R, an intermediate transfer apparatus H and two heating apparatuses K1 and K2 are united. It is noted that although an actual multi-chamber heat treatment apparatus includes three heating apparatuses, since FIG. 1 shows a cross-sectional view including a central axis (a central axis extending in the vertical direction) of the cooling apparatus R, the third heating apparatus is not shown therein. That is, the multi-chamber heat treatment apparatus 100 includes the cooling apparatus R, the intermediate transfer apparatus H and three heating apparatuses (including the heating apparatuses K1 and K2).

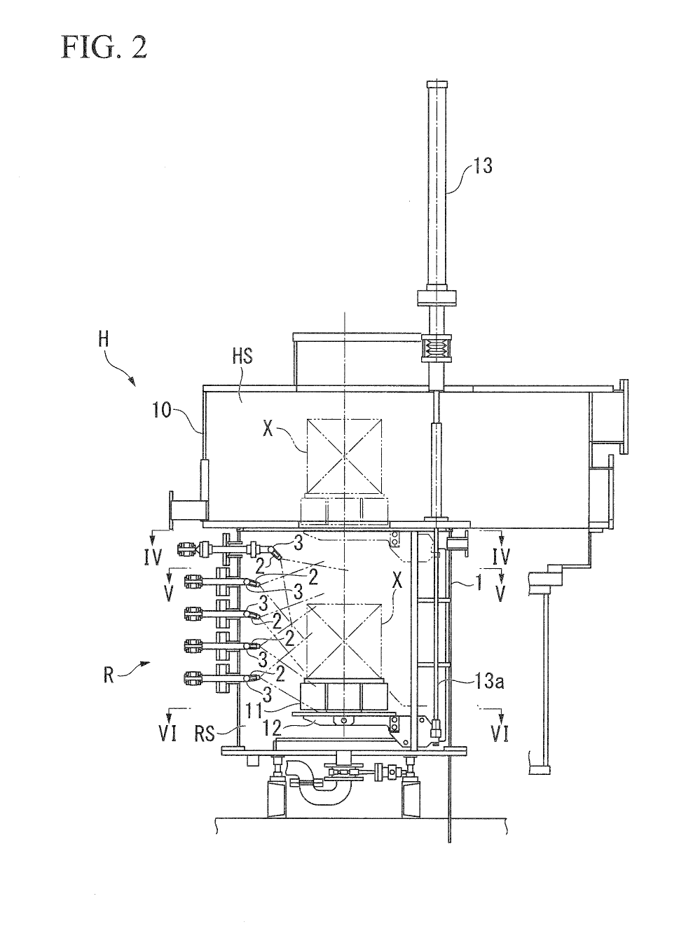

The cooling apparatus R is an apparatus that performs a cooling treatment on an object X to be treated. As shown in FIGS. 1 to 6, the cooling apparatus R includes a cooling chamber 1, a plurality of cooling nozzles 2, a plurality of mist headers 3 (header pipes), a cooling pump 4, a cooling drainpipe 5 (a cooling water discharge pipe), a cooling water tank 6, a cooling circulation pipe 7 (a cooling water circulation pipe), a plurality of stirring nozzles 8 and the like. In addition, the cooling circulation pipe 7 is omitted from FIG. 1.

The cooling chamber 1 is a vertical cylindrical casing (a casing whose central axis is parallel to the vertical direction), and the internal space of the cooling chamber 1 is a cooling room RS. The top of the cooling chamber 1 is connected to the intermediate transfer apparatus H, and the cooling chamber 1 is provided with an opening 1a through which the cooling room RS communicates with the internal space (a transfer room HS) of the intermediate transfer apparatus H. The object X to be treated (an object to be cooled) is loaded into the cooling room RS from the transfer room HS through the opening 1a, and the object X is unloaded from the cooling room RS into the transfer room HS therethrough.

As shown in FIGS. 1 to 3, the cooling nozzles 2 are dispersedly disposed (disposed in different positions) around the object X to be treated accommodated inside the cooling room RS. The cooling nozzles 2 are configured to spray (discharge) a cooling medium onto the object X to be treated. Specifically, the cooling nozzles 2 are dispersedly disposed around the object X to be treated in multilevel (specifically, in five levels) in the vertical direction at regular intervals in the circumferential direction of the cooling chamber 1 (the cooling room RS) so that the cooling nozzles 2 as a whole surround the object X to be treated and the distances between the cooling nozzles 2 and the object X to be treated are approximately equal to each other. The term “multilevel” denotes that a number of cooling nozzles 2 are provided in each of positions (areas) having different heights in the vertical direction. In addition, the cooling nozzles 2 of this embodiment are provided in a side area of the object X to be treated. The term “side area” does not only denote the area facing the side surface of the object X to be treated but also denotes an area horizontally next to the object X to be treated (an area different from the arrangement position of the object X to be treated in a horizontal direction), and the latter area may include a higher position than the upper end of the object X to be treated and a lower position than the lower end of the object X to be treated.

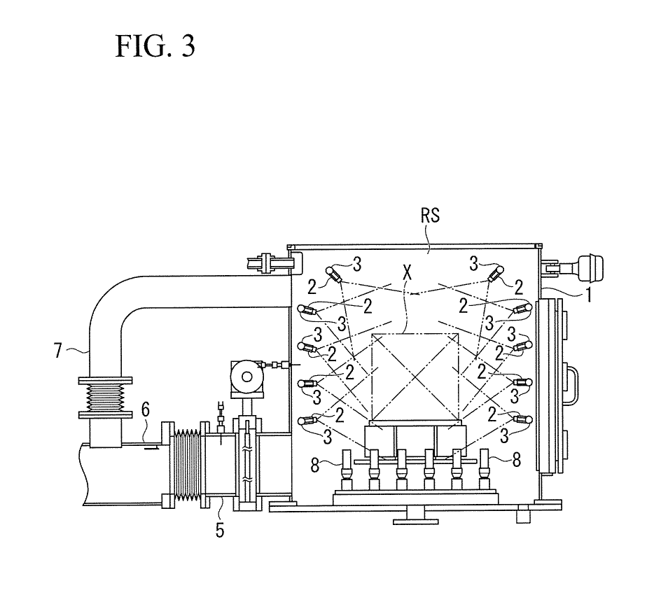

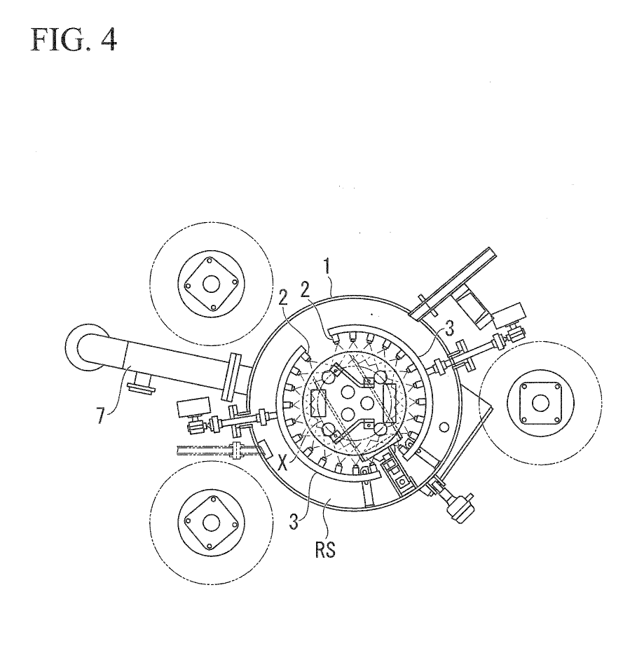

The cooling nozzles 2 are divided into groups. The cooling nozzles 2 are divided into two or more groups in a lateral direction (a horizontal direction) of the object X to be treated. A predetermined number of cooling nozzles 2 are included in each group, and the numbers of cooling nozzles 2 included in the groups may be equal to each other or may be different from each other. That is, the cooling nozzles 2 are divided into groups corresponding to levels in the vertical direction of the cooling room RS and are also divided into groups in the circumferential direction of the cooling chamber 1 (the cooling room RS). As shown in FIGS. 3 and 4, the groups (nozzle groups) are provided with the mist headers 3. That is, the mist header 3 is provided in each of the groups of the cooling nozzles 2.

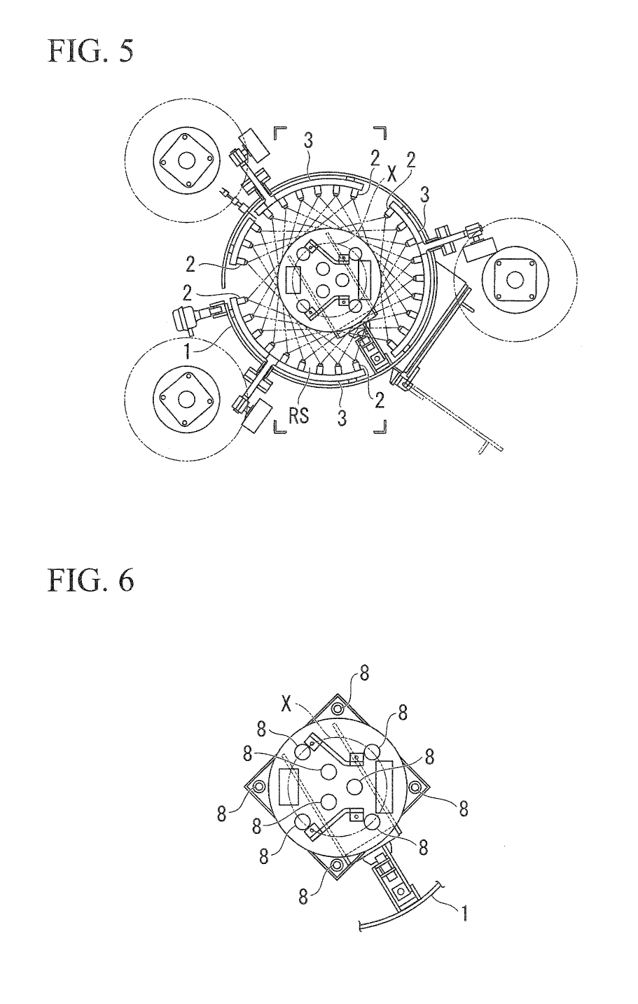

Specifically, the cooling nozzles 2 belonging to the uppermost level of all the cooling nozzles 2 are divided into two nozzle groups as shown in FIG. 4, and the two nozzle groups are provided with two mist headers 3. On the other hand, the cooling nozzles 2 belonging to each level of the lowermost and intermediate three levels thereof are divided into three nozzle groups as shown in FIG. 5, and the three nozzle groups are provided with three mist headers 3. Each cooling nozzle 2 of each nozzle group is adjusted so that the nozzle axis (the spray axis of the cooling medium) thereof extends to the object X to be treated, and mists the object X to be treated with the cooling medium supplied from the cooling pump 4 through the mist header 3.

As shown in FIGS. 1 and 3, the cooling nozzles 2 belonging to the uppermost level of all the cooling nozzles 2 are disposed in higher positions than the upper end of the object X to be treated in the vertical direction. On the other hand, the cooling nozzles 2 belonging to the lowermost level of all the cooling nozzles 2 are disposed in positions having heights approximately equivalent to that of the lower end of the object X to be treated. Furthermore, the cooling nozzles 2 belonging to the uppermost level are disposed in an inner area of the cooling nozzles 2 of another level (an inner area of the cooling room RS), that is, are disposed to be further separated from the inner surface of the cooling chamber 1 than the cooling nozzles 2 of another level. In other words, the cooling nozzles 2 of the uppermost level are disposed in positions closer to the central axis of the cooling chamber 1 (the cooling room RS) extending in the vertical direction than the cooling nozzles 2 of another level.

The cooling medium is a liquid having a lower viscosity than that of a cooling oil that is generally used for cooling of a heat treatment, and for example, is water. The shape of the spray hole of the cooling nozzle 2 is set so that a cooling medium such as water becomes uniform droplets having a fixed particle diameter at a predetermined spray angle. In addition, as shown in FIGS. 1 to 5, the spray angle of each cooling nozzle 2 and the separation between cooling nozzles 2 next to each other are set so that droplets positioned on a radially outer side of the cooling chamber 1 of droplets sprayed from a cooling nozzle 2 cross or collide with droplets positioned on a radially outer side of the cooling chamber 1 of droplets sprayed from another cooling nozzle 2 next thereto. In other words, the spray angle of each cooling nozzle 2 and the separation between cooling nozzles 2 next to each other are set so that droplets sprayed from nozzles next to each other cross each other or collide with each other before the droplets reach the object X to be treated.

That is, the cooling nozzles 2 having the above configuration spray the cooling medium onto the object X to be treated so that a mass of droplets of the cooling medium, namely mist of the cooling medium (cooling medium mist), surrounds the entire object X to be treated. It is preferable that the cooling medium mist be formed of droplets having uniform particle diameters and a uniform density around the object X to be treated.

The cooling apparatus R of this embodiment cools the object X to be treated using such cooling medium mist, that is, mist-cools the object X to be treated. The cooling conditions such as the cooling temperature, the cooling period of time and the like of the cooling apparatus R are appropriately set in accordance with the purpose of a heat treatment against the object X to be treated, the material of the object X to be treated and the like.

The mist headers 3 are pipes communicating with the cooling nozzles 2, and are provided in the above-described nozzle groups. That is, the mist headers 3 are provided in multilevel (five levels) in the vertical direction and a plurality (two or three) thereof are provided in the circumferential direction of the cooling chamber 1 (the cooling room

RS) so as to correspond to the above nozzle groups. Each mist header 3 is provided around the object X to be treated.

As shown in FIGS. 4 and 5, the shape of each mist header 3 is set into an arc shape along the inner surface of the cooling chamber 1 so that the distances between the mist header 3 and the cooling nozzles 2 are equal to each other, and each mist header 3 is attached with the cooling nozzles 2 at regular intervals in the circumferential direction thereof. In other words, a mist header 3 and the cooling nozzles 2 provided on the mist header 3 are configured so that the distances between the mist header 3 and the spray holes of the cooling nozzles 2 are approximately equal to each other. The mist headers 3 have approximately uniform pressure losses of the cooling medium with respect to the cooling nozzles 2, and thus distribute approximately uniform quantities of the cooling medium to the cooling nozzles 2.

The cooling apparatus R can perform cooling (immersion cooling) in which the object X to be treated is immersed in the cooling medium in addition to mist-cooling using the cooling medium mist for the object X to be treated. In the immersion cooling, the object X to be treated positioned inside the cooling chamber 1 is immersed in the cooling medium supplied from the stirring nozzles 8, and thereby it is cooled. That is, the discharge port of the cooling pump 4 is provided with a switching valve (not shown), and the cooling pump 4 supplies the cooling medium to either of the mist headers 3 and the stirring nozzles 8. In addition, it is preferable that a pump having a small variation in the discharge pressure of the cooling medium with respect to the passage of time be selected for the cooling pump 4. The cooling pump 4 may have any structure (a centrifugal pump, an axial-flow pump, a piston pump or the like) as far as the cooling pump 4 can supply the cooling medium to the mist headers 3 at a pressure needed for the spray operation of the cooling nozzles 2.

The cooling drainpipe 5 is a pipe through which the lower part of the cooling chamber 1 and the cooling water tank 6 communicate with each other, and the middle part of the cooling drainpipe 5 is provided with a drain valve (not shown). The cooling water tank 6 is a liquid container that stores the cooling medium released from the cooling chamber 1 through the cooling drainpipe 5 or the cooling circulation pipe 7. As shown in FIG. 3, the cooling circulation pipe 7 is a pipe through which the upper part of the cooling chamber 1 and the upper part of the cooling water tank 6 communicate with each other. The cooling circulation pipe 7 is used to return to the cooling water tank 6, the cooling medium having overflowed the cooling chamber 1 during the immersion cooling. As shown in FIGS. 3 and 6, the stirring nozzles 8 are dispersedly disposed (disposed in different positions) in the lower part of the cooling chamber 1. The stirring nozzles 8 supply the cooling medium into the cooling chamber 1 by injecting the cooling medium upward at the time of the immersion cooling, and after the cooling chamber 1 is filled with the cooling medium, the stirring nozzles 8 stir the cooling medium filled in the cooling chamber 1 by injecting the cooling medium upward during the immersion cooling.

The intermediate transfer apparatus H includes a transfer chamber 10, a cooling room-mounting table 11, a cooling room-lifting table 12, a cooling room-lifting cylinder 13, a pair of conveyance rails 14, a pair of pusher cylinders 15 and 16, a heating room-lifting table 17, a heating room-lifting cylinder 18 and the like. The transfer chamber 10 is a casing provided between the cooling apparatus R and the heating apparatuses K1 and K2, and the internal space of the transfer chamber 10 is the transfer room HS. The object X to be treated is loaded into the transfer chamber 10 through a loading-and-unloading opening (not shown) by a conveyance device provided outside of the intermediate transfer apparatus H in a state where the object X to be treated is contained in a container (a storage container) such as a basket. However, the object X to be treated may be loaded into the transfer chamber 10 without being contained in a storage container.

The cooling room-mounting table 11 is a support table on which the object X to be treated is mounted when the object X to be treated is cooled at the cooling apparatus R, and it is preferable that the cooling room-mounting table 11 support the object X to be treated so that the bottom of the object X to be treated is widely exposed. The cooling room-mounting table 11 is provided on the top of the cooling room-lifting table 12. The cooling room-lifting table 12 is a support table that supports the cooling room-mounting table 11, that is, is a support table that supports the object X to be treated through the cooling room-mounting table 11, and is fixed to the end of a movable rod 13a of the cooling room-lifting cylinder 13.

The cooling room-lifting cylinder 13 is an actuator that vertically moves (lifts up and lowers) the cooling room-lifting table 12. That is, the cooling room-lifting cylinder 13 and the cooling room-lifting table 12 are conveyance devices that are used exclusively for the cooling apparatus R, and convey the object X to be treated mounted on the cooling room-mounting table 11 from the transfer room HS into the cooling room RS and convey it from the cooling room RS into the transfer room HS.

The pair of conveyance rails 14 is laid on the floor inside the transfer chamber 10 so as to extend in a horizontal direction. The conveyance rails 14 are guide members that are used when the object X to be treated is conveyed between the cooling apparatus R and the heating apparatus K1. The pusher cylinder 15 is an actuator that pushes the object X to be treated when the object X to be treated positioned inside the transfer chamber 10 is conveyed toward the heating apparatus K1. The pusher cylinder 16 is an actuator that pushes the object X to be treated when the object X to be treated is conveyed from the heating apparatus K1 to the cooling apparatus R.

That is, the pair of conveyance rails 14 and the pusher cylinders 15 and 16 are conveyance devices that are used exclusively for conveying the object X to be treated between the heating apparatus K1 and the cooling apparatus R. It is noted that although the pair of conveyance rails 14 and the pusher cylinders 15 and 16 are shown in FIG. 1, the actual intermediate transfer apparatus H includes three sets of two conveyance rails 14 and pusher cylinders 15 and 16. That is, the two conveyance rails 14 and pusher cylinders 15 and 16 are not only provided for the heating apparatus K1 but are also provided for each of the heating apparatus K2 and the third heating apparatus (not shown).

The heating room-lifting table 17 is a support table on which the object X to be treated is mounted when the object X to be treated is conveyed from the intermediate transfer apparatus H to the heating apparatus K1. That is, the object X to be treated is conveyed to a position right above the heating room-lifting table 17 by being pushed rightward in FIG. 1 by the pusher cylinder 15. The heating room-lifting cylinder 18 is an actuator that vertically moves (lifts up and lowers) the object X to be treated placed on the heating room-lifting table 17. That is, the heating room-lifting table 17 and the heating room-lifting cylinder 18 are conveyance devices that are used exclusively for the heating apparatus K1, and convey the object X to be treated mounted on the heating room-lifting table 17 from the transfer room HS to the inside (a heating room KS) of the heating apparatus K1 and convey it from the heating room KS into the transfer room HS.

Next, since the heating apparatuses K1 and K2 (and the third heating apparatus) have basically the same structure, hereinafter, the structure of the heating apparatus K1 is described on their behalf. The heating apparatus K1 includes a heating chamber 20, a thermal insulation casing 21, a plurality of heaters 22, a vacuum extraction pipe 23, a vacuum pump 24, a stirring blade 25, a stirring motor 26 and the like.

The heating chamber 20 is a casing provided above the transfer chamber 10, and the internal space of the heating chamber 20 is the heating room KS. The heating chamber 20 is a vertical cylindrical casing (a casing whose central axis is parallel to the vertical direction) similar to the cooling chamber 1, and is formed in a smaller size than the cooling chamber 1. The thermal insulation casing 21 is a vertical cylindrical casing provided inside the heating chamber 20, and is formed of a thermal insulation material having a predetermined thermal insulation property.

The heaters 22 are bar-shaped heating elements and are provided inside the thermal insulation casing 21 in vertical attitudes at predetermined intervals in the circumferential direction of the thermal insulation casing 21. The heaters 22 heat the object X to be treated accommodated in the heating room KS to an intended temperature (a heating temperature). The heating conditions such as the heating temperature and the heating period of time are appropriately set in accordance with the purpose of a heat treatment with respect to the object X to be treated, the material of the object X to be treated and the like.

The above heating conditions include the vacuum degree (the pressure, the air pressure) inside the heating room KS (the heating chamber 20). The vacuum extraction pipe 23 is a pipe communicating with the heating room KS, and a first end of the vacuum extraction pipe 23 is connected to the top of the thermal insulation casing 21, and a second end thereof is connected to the vacuum pump 24. The vacuum pump 24 is an air extraction pump that sucks air inside the heating room KS through the vacuum extraction pipe 23. The vacuum degree inside the heating room KS is determined by the extraction volume of air of the vacuum pump 24.

The stirring blade 25 is a rotary blade provided in the upper part inside the thermal insulation casing 21 in an attitude in which the extending direction of the rotary shaft thereof is parallel to the vertical direction (the up-and-down direction). The stirring blade 25 is driven by the stirring motor 26, and thereby stirs air (gas) inside the heating room KS. The stirring motor 26 is a rotational drive source provided on the top of the heating chamber 20 so that the extending direction of the output shaft thereof is parallel to the vertical direction (the up-and-down direction). The output shaft of the stirring motor 26 positioned on the heating chamber 20 is axially connected to the rotary shaft of the stirring blade 25 positioned inside the heating chamber 20 without spoiling the airtightness (the sealing property) of the heating chamber 20.

Although not shown in FIGS. 1 to 6, the multi-chamber heat treatment apparatus 100 of this embodiment includes a control board (a controller) that is used exclusively therefor. The control board includes an operating portion that is used in order that a user inputs and sets various conditions (setting information) of a heat treatment, and a control portion that carries out the heat treatment on the object X to be treated in accordance with the setting information by controlling each component of the cooling pump 4, the heaters 22, the cylinders, the vacuum pump 24 and the like in accordance with control programs stored therein beforehand.

Next, the operation (a heat treatment method) of the multi-chamber heat treatment apparatus 100 having the above configuration, particularly the operation (a cooling treatment method) of the cooling apparatus R, is described in detail. The above control board dominantly carries out the operation of the multi-chamber heat treatment apparatus 100 in accordance with the setting information. In addition, as it is well known, there are various kinds of heat treatments for different purposes. Hereinafter, the operation of quenching the object X to be treated is described as an example of the heat treatments.

In quenching, for example, the object X to be treated is heated up to a temperature T1, thereafter is rapidly cooled to a temperature T2, and is maintained in the temperature T2 for a fixed period of time, thereafter is slowly cooled to a lower temperature than the temperature T2, whereby the quenching is finished. The object X to be treated having been carried into the intermediate transfer apparatus H through the loading-and-unloading opening by the external conveyance device is conveyed onto the heating room-lifting table 17 through, for example, the operation of the pusher cylinder 15, and is carried into the heating room KS through the operation of the heating room-lifting cylinder 18.

Then, the object X to be treated is heated to the temperature T1 by heat generated from the heaters 22 when the heaters 22 are energized for a fixed period of time, thereafter is conveyed from the heating room KS into the intermediate transfer apparatus H through the operation of the heating room-lifting cylinder 18, is conveyed onto the cooling room-mounting table 11 through the operation of the pusher cylinder 16, and furthermore, is conveyed into the cooling room RS through the operation of the cooling room-lifting cylinder 13.

At this time, the cooling room RS is in a state of being filled with the cooling medium because the cooling pump 4 operates in advance and the stirring nozzles 8 supply the cooling medium thereinto. Thus, the object X to be treated is immersed in the cooling medium and is rapidly cooled to the temperature T2 (immersion cooling). The immersion cooling is performed for a predetermined period of time, and in the immersion cooling, the cooling medium filled in the cooling room RS is stirred by the stirring nozzles 8 continuously supplying the cooling medium into the cooling room RS, and the cooling medium having overflowed the cooling room RS is returned to the cooling water tank 6 through the cooling circulation pipe 7.

Then, when the immersion cooling is finished, the drain valve of the cooling drainpipe 5 is opened, the cooling medium inside the cooling room RS is drained into the cooling water tank 6 through the cooling drainpipe 5 in a short period of time, and thereby the object X to be treated is brought from a state of being immersed in the cooling medium into a state of being placed in air (gas) in a short period of time. Then, after the object X to be treated is placed therein for a predetermined period of time, the discharge port of the cooling pump 4 is switched from the cooling circulation pipe 7 to the mist headers 3, the cooling pump 4 operates again, and thereby droplets (mist) of the cooling medium are sprayed from the cooling nozzles 2 onto the object X to be treated. That is, the object X to be treated is mist-cooled by droplets of the cooling medium sprayed from the cooling nozzles 2.

In the mist-cooling, as described above, the mist headers 3 are provided in the nozzle groups, and specifically, the cooling nozzles 2 provided in the side area around the object X to be treated are divided in two groups at the uppermost level and are divided into three groups at each level of the lowermost and intermediate three levels. That is, the cooling medium discharged from the cooling pump 4 is uniformly supplied to the cooling nozzles 2 compared to a case where a cooling medium is supplied to cooling nozzles through a single mist header in the related art. Thus, the droplets of the cooling medium discharged from the cooling nozzles 2 are uniformly sprayed onto various parts of the object X to be treated, and as a result, the entire object X to be treated is uniformly mist-cooled.

In the mist-cooling, since the mist headers 3 are provided in multilevel (five levels) in the up-and-down direction, it is possible to spray droplets of the cooling medium onto a wide area of the surface of the object X to be treated, and thereby the entire object X to be treated is also uniformly mist-cooled.

A cooling nozzle 2 of the uppermost level is disposed above the upper end of the object X to be treated and is disposed in an inner area of a cooling nozzle 2 of another level inside the cooling room RS, and thereby the distance between the object X to be treated and the cooling nozzle 2 of the uppermost level is set to be approximately equivalent to the distance between the object X to be treated and the cooling nozzle 2 of the other level. Accordingly, droplets of the cooling medium act on the top of the object X to be treated similarly to another part thereof, and the top of the object X to be treated is uniformly mist-cooled in a manner similar to the other part.

Hereinbefore, although an embodiment of the present disclosure is described with reference to the attached drawings, the present disclosure is not limited to the above embodiment. The shape, the combination or the like of each component shown in the above embodiment is an example, and addition, omission, replacement, and other modifications of a configuration based on a design request or the like can be adopted within the scope of the present disclosure. For example, the following modifications may be adopted.

(1) Although the multi-chamber heat treatment apparatus, which includes the cooling apparatus R, the intermediate transfer apparatus H and the three heating apparatuses, is described in the above embodiment, the present disclosure is not limited thereto. The present disclosure can also be applied to, for example, a multi-chamber heat treatment apparatus in which a cooling apparatus R and a single heating room are adjacent to each other through an opening-and-closing door.

(2) The arrangement configuration of the mist headers 3 (header pipes) of the above embodiment, namely the configuration of grouping of the cooling nozzles 2, is just one example, and various modifications may be adopted as needed. For example, the number of levels of the cooling nozzles 2 in the vertical direction may be four or less or six or more as needed, and the number of nozzle groups in the circumferential direction may be a number other than two or three.

(3) Although the cooling apparatus R of the above embodiment is an apparatus in which the object X to be treated is carried into the cooling room RS from the upper side thereof, the present disclosure is not limited thereto. The present disclosure can also be applied to a cooling apparatus in which the object X to be treated is carried into the cooling room thereof from the lateral side (in a horizontal direction) or from the lower side thereof.

(4) In the above embodiment, although the cooling nozzles 2 of the lowermost level of all the cooling nozzles 2 are disposed in positions having heights approximately equivalent to the lower end of the object X to be treated, the present disclosure is not limited thereto. For example, the cooling nozzles 2 of the lowermost level may be disposed in lower positions than the lower end of the object X to be treated in the vertical direction. In addition, the cooling nozzles 2 of the lowermost level may be provided in an inner area of the cooling nozzles 2 of an intermediate level inside the cooling room RS. In this case, the cooling room-mounting table 11 may have a lattice structure (a structure through which droplets can pass) in order that droplets sprayed from the cooling nozzles 2 of the lowermost level can efficiently reach the object X to be treated.

### INDUSTRIAL APPLICABILITY

The present disclosure can be applied to a cooling apparatus that cools an object to be treated using a cooling medium, and to a multi-chamber heat treatment apparatus including the cooling apparatus.

1. A cooling apparatus comprising:
cooling nozzles which are disposed around an object to be treated accommodated inside a cooling room and spray a cooling medium onto the object to be treated;
a header pipe communicating with the cooling nozzles; and
a cooling pump which supplies the cooling medium to the header pipe;
wherein the cooling nozzles are divided into groups, and
wherein the header pipe is provided in each of the groups of the cooling nozzles.

2. The cooling apparatus according to claim 1,
wherein the cooling nozzles are divided into two or more groups in a lateral direction of the object to be treated.

3. The cooling apparatus according to claim 1,
wherein the cooling nozzles are provided in multilevel in an up-and-down direction in a side area of the object to be treated.

4. The cooling apparatus according to claim 2,
wherein the cooling nozzles are provided in multilevel in an up-and-down direction in a side area of the object to be treated.

5. The cooling apparatus according to claim 3,
wherein a cooling nozzle of the uppermost level of the cooling nozzles is disposed in a higher position than the upper end of the object to be treated, and is disposed in an inner area of a cooling nozzle of another level of the cooling nozzles inside the cooling room.

6. The cooling apparatus according to claim 4,
wherein a cooling nozzle of the uppermost level of the cooling nozzles is disposed in a higher position than the upper end of the object to be treated, and is disposed in an inner area of a cooling nozzle of another level of the cooling nozzles inside the cooling room.

7. The cooling apparatus according to claim 1,
wherein the header pipe is provided around the object to be treated, and is formed so that the distances between the header pipe and the cooling nozzles are equal to each other.

8. A multi-chamber heat treatment apparatus comprising:
a heating apparatus which heats an object to be treated; and
the cooling apparatus according to claim 1.
